(19) United States
(12) Patent Application Publication
(10) Pub. No.: US 2023/0133193 A1
(43) Pub. Date: May 4, 2023

(54) METHOD AND DEVICE FOR RAPIDLY FORMING ARTIFICIAL CLAY AND ARTIFICIAL ORGANIC ECOLOGICAL MUD

(71) Applicant: Institute of Rock and Soil Mechanics, CAS, Hubei Province (CN)

(72) Inventors: Bing BAI, Hubei Province (CN); Huiling CI, Hubei Province (CN); Yinxiang CUI, Hubei Province (CN); Hongwu LEI, Hubei Province (CN)

(21) Appl. No.: 17/876,126

(22) Filed: Jul. 28, 2022

(30) Foreign Application Priority Data
Aug. 2, 2021 (CN) 202110880410.X

(51) Int. Cl. C05G 1/00; A01G 24/15; A01G 24/60; A01G 24/42; C05G 5/40; C05F 11/08; C05C 9/00; C05D 9/00

(52) U.S. Cl. CPC C05G 1/00; A01G 24/15; A01G 24/60; A01G 24/42; C05G 5/40; C05F 11/08; C05C 9/005; C05D 9/00

(57) ABSTRACT

The present disclosure belongs to the technical field of ecological environmental protection, resource development and utilization and new materials, and particularly relates to a method and device for rapidly forming artificial clay and artificial organic ecological mud. The method comprises the following steps: raw material and water storage preparation; preparing nutrient aqueous solution; preparing mineral muddy water; preparing flocculent mineral solution; and reacting and dehydrating to form artificial clay or artificial organic ecological mud. The device comprises a grinding mill, a feeding system, a silo, a belt conveyor, an agitator, a dehydration system and a reservoir. In accordance with the present disclosure, the formation period of natural clay is greatly shortened by artificial means, making the clay become a renewable resource.

### CROSS REFERENCE TO RELATED APPLICATION

This patent application claims the benefit and priority of Chinese Patent Application No. 202110880410.X, filed on Aug. 2, 2021, the disclosure of which is incorporated by reference herein in its entirety as part of the present application.

### TECHNICAL FIELD

The present disclosure belongs to the technical fields of ecological environmental protection, resource development and utilization and new materials, and particularly relates to a method and device for rapidly forming artificial clay and artificial organic ecological mud.

### BACKGROUND ART

Although China has a large land space, the proportion of ecologically fragile or ecologically degraded areas is still high, typically such as stone desertification, desertification, sandification, salinization, and the like. In China, the land areas in desertification and sandification respectively account for more than ¼ and ⅙ of the territorial area, ecological remediation of these areas is an important task and of a great value. Therefore, management and development of these land spaces not only can protect land resources and improve the local ecological environment, but also can increase ecological carbon sink and help achieve carbon neutrality, which plays a comprehensive and fundamental role and is of great significance. The soil problem, either the degradation of soil quality or erosion of soil, is one of the root causes of the deterioration of these land spaces. With high-quality soil, effective management, even ecological remediation, of ecologically fragile or ecologically degraded areas may be achieved. On the other hand, there is a growing demand for soil in many industries, including the industries of agriculture, construction and the like, as well as daily life demands. As natural soil is formed by natural weathering of surface rocks, with a very long formation period, the natural soil is a precious non-renewable resource to a certain extent. Soil is also no longer freely tradable and readily available due to strict ecological protection regulation and other reasons. The soil, especially high-quality planting soil itself, has become a scarce resource. This is the reason why artificial soil matrix has been gaining importance recently.

In agrology, the soil is divided into three main types: sandy soil, loamy soil, and clay. In general, the sandy soil has good permeability but weak water/fertilizer retention, while the clay is the opposite. The loamy soil has achieved a good balance between water permeability and air permeability and water/fertilizer retention due to its texture, and is the most suitable type for agricultural cultivation. In the improvement and practice of sandy soil, an important measure is the addition of clay (called “clay adding”), which may form a sand-clay matched loam structure. Therefore, clay plays an important role in the improvement of sandy soil. As the artificial sandy soil and the artificial soil matrix are relatively easy to manufacture, and most natural sandy soil exists in desertification areas, the remediation and management of these areas can be attributed to the problem of obtaining clay. But likewise, compared to the natural sandy soil, the natural clay is much longer in the age of formation, harsher in conditions, more non-renewable, scarce, strictly protected, and more difficult to obtain.

Therefore, it is undoubtedly of a great value to artificially produce similar material or even the same material of the natural clay, namely, artificial clay, on a large scale, at low cost and with high efficiency. If the artificial clay is prepared to have certain biological activity or nutrient fertilization, it is undoubtedly more beneficial to the improvement of planting quality of the soil and growth of crops. Such artificial clay is called artificial organic ecological mud. That is the objective of the present disclosure. It should be noted that the artificial clay and artificial organic ecological mud of the present disclosure are oriented mainly to ecological improvement, agricultural cultivation and the like. Such artificial clay is a completely different thing from the so-called clay in the children's handicraft and toy industry. Similarly, such organic ecological mud is a completely different material from the decoration materials in the home decoration industry.

### SUMMARY

For the problems in the prior art, the present disclosure provides a method and device for rapidly forming artificial clay and artificial organic ecological mud, relating to a method and a device for rapidly preparing artificial clay by artificial means and preparing artificial organic ecological mud with the assistance of various additives.

To achieve the objective, the present disclosure employs the following technical solutions:

A method for rapidly forming artificial clay and artificial organic ecological mud specifically comprises the following steps:
step one: raw material preparation and water storage preparation;
selecting the desired types of rocks, soil particles or mining industry solid wastes or various other materials having a particle size greater than a target particle size as a raw material, and grinding the raw material to the target particle size; or directly using an existing material having a particle size smaller than or equal to the target particle size; and preparing water;
step two: preparing mineral muddy water;
in a case of preparing the artificial clay, performing a sub-step a; in a case of preparing the artificial organic ecological mud, performing a sub-step b;
the sub-step a, pouring a designed amount of raw material in the step one into a designed amount of water prepared in the step one, stirring while pouring the raw material to avoid bubbling and caking in the process, and after the raw material is completely poured into the water, continuing to stir until the raw material and the water are completely and uniformly mixed, thus obtaining the mineral muddy water;
the sub-step b, pouring a designed amount of organic material into a designed amount of water prepared in the step one, stirring while pouring the organic material until the organic material and the water are completely and uniformly mixed, thus obtaining nutrient aqueous solution, wherein the organic material is a mixture of microbial inoculants and one or more of organic fertilizers, inorganic fertilizers, biological fertilizers, and crushed organic materials;
pouring the designed amount of the raw material in the step one into the nutrient aqueous solution, stirring while pouring the raw material to avoid bubbling and caking in the process, and after the raw material is completely poured into the nutrient aqueous solution, continuing to stir until the raw material and the nutrient aqueous solution are completely and uniformly mixed, thus obtaining the mineral muddy water;
step three: preparing flocculent mineral solution;
taking a designed amount of a mixture of one or more of flocculants, aggregating agents or water-retaining agents, pouring the mixture into the prepared mineral muddy water, and stirring while pouring the mixture until the mixture and the mineral muddy water are completely and uniformly mixed, thus forming the flocculent mineral solution; and
step four: reacting and dehydrating to form artificial clay or artificial organic ecological mud;
reserving reaction time according to the reaction time of not less than 24 hours, enabling substances in the flocculent mineral solution prepared in step three to fully react, and then conveying the flocculent mineral solution to the dehydration system to be concentrated, filter-pressed and compressed to obtain the artificial clay or artificial organic ecological mud.

The target particle size in the step one has an upper value limit of 5 μm.

In the step four, the reaction time is reserved according to the reaction time of 72 hours per ton of granules.

A device for rapidly forming artificial clay and artificial organic ecological mud comprises a grinding mill 1, a feeding system 2, a silo 3, a belt conveyor 4, an agitator 5, a dehydration system 6, and a reservoir 7, wherein a discharge port of the grinding mill 1 communicates with a feed port of the feeding system 2 via the belt conveyor 4, a discharge port of the feeding system 2 communicates with an inlet of the silo 3 via the belt conveyor 4, an outlet of the silo 3 communicates with an inlet of the dehydration system 6 via a first water pipe 81, an outlet of the dehydration system 6 communicates with the reservoir 7 via a second water pipe 82, and the agitator 5 is arranged in the silo 3.

The feeding system 2 comprises a ground material feeding container 21, an organic material feeding container 22 and a flocculation feeding container 23, wherein the ground material feeding container 21 is used for storing the material having the target particle size; the organic material feeding container 22 is used for storing the organic materials, and the flocculation feeding container 23 is used for storing a mixture of one or more of flocculants, aggregating agents or water-retaining agents; and the three feeding containers are used for feeding the silo 3 via the belt conveyor 4.

The belt conveyor 4 comprises a first belt conveyor 41 and a second belt conveyor 42, wherein the discharge port of the grinding mill 1 communicates with a feed port of the first belt conveyor 41, a discharge port of the first belt conveyor 41 communicates with a feed port of the ground material feeding container 21, a discharge port of the ground material feeding container 21, a discharge port of the organic material feeding container 22, and a discharge port of the flocculation feeding container 23 all communicate with a feed port of the second belt conveyor 42, and a discharge port of the second belt conveyor 42 communicates with the inlet of the silo 3.

The agitator 5 comprises a driving motor, a connecting rod, and stirring impellers, wherein the top of the connecting rod is connected to an output shaft of the driving motor to rotate under the driving of the output shaft of the driving motor, a plurality of stirring impellers are fixed to the lower side of the connecting rod, the connecting rod with the stirring impellers extend into the silo 3, and the driving motor is fixed to the top of the silo 3.

A method for rapidly forming artificial clay and artificial organic ecological mud by using the device above comprises the following steps:
step one: raw material preparation and reaction pool preparation;
selecting the desired types of rocks, soil particles or mining industry solid wastes or various other materials having a particle size greater than a target particle size as a raw material, and grinding the raw material to the target particle size by the grinding mill 1; or directly using an existing material having a particle size smaller than or equal to the target particle size; conveying the raw material having the target particle size via the first belt conveyor 41 and then storing the raw material in the ground material feeding container 21; and
adding a desired designed amount of water to the silo 3;
step two: preparing mineral muddy water;
in a case of preparing the artificial clay, performing a sub-step a; in a case of preparing the artificial organic ecological mud, performing a sub-step b;
the sub-step a, extracting a desired designed amount of raw material from the ground material feeding container 21, and conveying the raw material into the silo 3 via the second belt conveyor 42, with the agitator 5 continuously stirring during conveying to prevent the raw material entering the silo 3 from bubbling and caking, and after the raw material is completely poured into the silo 3, continuing to stir by the agitator 5 until the raw material and the water are completely and uniformly mixed, thus obtaining the mineral muddy water;
the sub-step b, extracting a desired designed amount of organic material from the organic material feeding container 22, and conveying the organic material into the silo 3 via the second conveyor belt 42, with the agitator 5 continuously stirring during conveying until the organic material and the water are completely and uniformly mixed, thus obtaining nutrient aqueous solution;
extracting the desired designed amount of the raw material from the ground material feeding container 21, and conveying the raw material into the silo 3 via the second belt conveyor 42, with the agitator 5 continuously stirring during conveying to prevent the raw material entering the silo 3 from bubbling and caking, and after the designed amount of raw material is completely poured into the silo 3, continuing to stir by the agitator 5 until the raw material and the nutrient aqueous solution are completely and uniformly mixed, thus obtaining the mineral muddy water;
step three: preparing flocculent mineral solution;
extracting a desired designed amount of a mixture of one or more of flocculants, aggregating agents or water-retaining agents from the flocculation feed container 23, and then conveying the mixture into the silo 3 via the second belt conveyor 42, with the agitator 5 continuously stirring during conveying until the mixture and the mineral muddy water are completely and uniformly mixed, thus forming the flocculent mineral solution; and
step four: reacting and dehydrating to form artificial clay or artificial organic ecological mud;
reserving reaction time according to the reaction time of not less than 24 hours, enabling substances in the flocculent mineral solution prepared in step three to fully react, and then conveying the flocculent mineral solution into the dehydration system 6 via the first water pipe 81 to be concentrated, filter-pressed and compressed to obtain the artificial clay or artificial organic ecological mud, wherein the wastewater generated in the dehydration process is conveyed into the reservoir 7 via the second water pipe 82.

The organic material selected in the step two is a mixture of microbial inoculants and one or more of organic fertilizers, inorganic fertilizers, biological fertilizers, and crushed organic materials.

Compared with the prior art, the present disclosure has the following beneficial effects that:

(1) The formation period of the natural clay is greatly shortened by artificial means, making the clay become a renewable resource.

(2) The raw materials for preparing the artificial clay and artificial organic ecological mud are wide in source, which may be rocks, solid waste (such as coal gangue), natural sandy soil, natural waste soil, other artificial materials, and the like. In particular, a practical path can be provided for the treatment and resource utilization of the solid waste, and the ecological environment can also be protected.

(3) Various additives are added while the clay is prepared, which is not only conducive to accelerating the formation of the clay, but also conducive to accelerating the curing of the clay, thus such clay has great advantages compared with the “immature” natural clay (often called “raw soil”).

(4) One of the artificial clay and the artificial organic ecological mud or a combination thereof can be used for clay-adding improvement of sandy soil (artificial sandy soil or natural sandy soil), which is conducive to further preparing the artificial loamy soil or improving natural sandy soil into loamy soil that is more suitable for cultivation and growth of crops.

(5) The artificial clay and artificial organic ecological mud can be rapidly formed on a large scale and at low cost in accordance with the present disclosure. The method and device have the characteristics of high yield, scientific production process, simplicity and effectiveness. The prepared artificial clay and artificial organic ecological mud may be further applied to unfavorable geology such as stony desertification, desertification, sandification, salinization and the like as an amendment. It is expected to provide a reliable and stable source of clay for ecological restoration and treatment process to facilitate the transformation of natural or artificial soil substrate to real soil, thus building a good ecological environment.

### BRIEF DESCRIPTION OF THE DRAWINGS

FIG. 1 is a flow chart of a method for rapidly forming artificial clay and artificial organic ecological mud of the present disclosure.

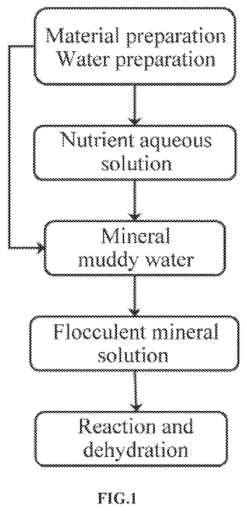

FIG. 2 is a diagram of a device for rapidly forming artificial clay and artificial organic ecological mud of the present disclosure.

In the drawings: 1-grinding mill; 2-feeding system; 21-ground material feeding container; 22-organic material feeding container; 23-flocculation feeding container; 3-silo; 4-belt conveyor; 41-first belt conveyor; 42-second belt conveyor; 5-agitator; 6-dehydration system; 7-reservoir; 8-water pipe; 81-first water pipe; 82-second water pipe; 9-finished product-artificial clay or artificial organic ecological mud.

### DETAILED DESCRIPTION OF THE EMBODIMENTS

According to the method and the device provided by the present disclosure, the weathering process is accelerated by the artificial means, thus making a non-sticky material form artificial clay similar to, or the same as, natural clay in an accelerated manner. By applying organic materials, supplementing inorganic substances, organic substances and nutritional ingredients, a certain of biological activity and nutritional fertility are provided to form artificial organic ecological mud. By adding flocculants, aggregating agents and water-retaining agents, the fine material may form an aggregated structure with water-retaining and fertilizer-retaining capabilities, further forming water-retaining and fertilizer-retaining components. Raw materials for preparing used in the method and the device comprise, but are not limited to, rocks or sand or sandy soil, even solid waste, other artificial materials and the like, thus the sources are wide, obtaining materials from local sources and adaption to the local circumstances may be achieved. The method and device in the present disclosure are environmentally friendly as no gas, solids or liquid harmful to the environment are discharged during the whole process. More importantly, the artificial clay and artificial organic ecological mud prepared by the method and device in the present disclosure may improve the artificial or natural sandy soil, such as building a sand-clay loam structure to form artificial loam or natural loam, which is more suitable for cultivation and growth of crops.

The artificial clay provided by the present disclosure is a similar material, or even the same material, of the natural clay prepared by an artificial means, and is a soil-like material with cohesiveness, plasticity and good texture. The artificial organic ecological mud provided by the present disclosure is an artificial soil-like material with a certain of biological activity and nutrient fertility, which is formed by scientific proportioning of various additives on the basis of the artificial clay.

To achieve the objective, the present disclosure employs the following technical solutions:

A method for rapidly forming artificial clay and artificial organic ecological mud specifically comprises the following steps:
step one: raw material preparation and water storage preparation;
selecting the desired types of rocks, soil particles or mining industry solid wastes or various other materials having a particle size greater than a target particle size as a raw material, and grinding the raw material to the target particle size; or directly using an existing material having a particle size smaller than or equal to the target particle size; and preparing water;
step two: preparing mineral muddy water;
in a case of preparing the artificial clay, performing a sub-step a; in a case of preparing the artificial organic ecological mud, performing a sub-step b;
the sub-step a, pouring a designed amount of raw material in the step one into a designed amount of water prepared in the step one, stirring while pouring the raw material to avoid bubbling and caking in the process, and after the raw material is completely poured into the water, continuing to stir until the raw material and the water are completely and uniformly mixed, thus obtaining the mineral muddy water;
the sub-step b, pouring a designed amount of organic material into a designed amount of water prepared in the step one, stirring while pouring the organic material until the organic material and the water are completely and uniformly mixed, thus obtaining nutrient aqueous solution, wherein the organic material is a mixture of microbial inoculants and one or more of organic fertilizers, inorganic fertilizers, biological fertilizers, and crushed organic materials; specifically, the mixture should be determined according to the raw material type in the step one, if the raw material lacks nitrogen, the organic material should contain nitrogen fertilizers, and if the raw material lacks potassium, the organic material should contain potassium fertilizers;
pouring the designed amount of the raw material in the step one into the nutrient aqueous solution, stirring while pouring the raw material to avoid bubbling and caking in the process, and after the raw material is completely poured into the nutrient aqueous solution, continuing to stir until the raw material and the nutrient aqueous solution are completely and uniformly mixed, thus obtaining the mineral muddy water;
step three: preparing flocculent mineral solution;
taking a designed amount of a mixture of one or more of flocculants, aggregating agents or water-retaining agents, and pouring the mixture into the prepared mineral muddy water, and stirring while pouring the mixture until the mixture and the mineral muddy water are completely and uniformly mixed, thus forming the flocculent mineral solution; and
step four: reacting and dehydrating to form artificial clay or artificial organic ecological mud;
reserving the reaction time according to the reaction time of 72 hours per ton of granules (the reaction time for one ton of granules is 72 hours, which is increased in equal proportion, but at least 24 hours), enabling the substances in the flocculent mineral solution prepared in step three to fully react, and then conveying the flocculent mineral solution to the dehydration system to be concentrated, filter-pressed and compressed to obtain the artificial clay or the artificial organic ecological mud.

The target particle size in the step one has an upper value limit of 5 μm.

A device for rapidly forming artificial clay and artificial organic ecological mud comprises a grinding mill 1, a feeding system 2, a silo 3, a belt conveyor 4, an agitator 5, a dehydration system 6, and a reservoir 7. A discharge port of the grinding mill 1 communicates with a feed port of the feeding system 2 via the belt conveyor 4, a discharge port of the feeding system 2 communicates with an inlet of the silo 3 via the belt conveyor 4, an outlet of the silo 3 communicates with an inlet of the dehydration system 6 via a first water pipe 81, an outlet of the dehydration system 6 communicates with the reservoir 7 via a second water pipe 82, and the agitator 5 is arranged in the silo 3.

The feeding system 2 comprises a ground material feeding container 21, an organic material feeding container 22 and a flocculation feeding container 23, wherein the ground material feeding container 21 is used for storing a material having a target particle size; the organic material feeding container 22 is used for storing an organic material, and the flocculation feeding container 23 is used for storing a mixture of one or more of flocculants, aggregating agents or water-retaining agents; and the three feeding containers are used for feeding the silo 3 via the belt conveyor 4.

The belt conveyor 4 comprises a first belt conveyor 41 and a second belt conveyor 42, wherein the discharge port of the grinding mill communicates with a feed port of the first belt conveyor 41, a discharge port of the first belt conveyor 41 communicates with a feed port of the ground material feeding container 21, a discharge port of the ground material feeding container 21, a discharge port of the organic material feeding container 22, and a discharge port of the flocculation feeding container 23 all communicate with a feed port of the second belt conveyor 42, and a discharge port of the second belt conveyor 42 communicates with the inlet of the silo 3.

The agitator 5 comprises a driving motor, a connecting rod, and stirring impellers, wherein the top of the connecting rod is connected to an output shaft of the driving motor to rotate under the driving of the output shaft of the driving motor, a plurality of stirring impellers are fixed to the lower side of the connecting rod, the connecting rod with the stirring impellers extend into the silo 3, and the driving motor is fixed to the top of the silo 3.

A method for rapidly forming artificial clay and artificial organic ecological mud by using the device above comprises the following steps:
step one: raw material preparation and reaction pool preparation;
selecting the desired types of rocks, soil particles or mining industry solid wastes or various other materials having a particle size greater than a target particle size as a raw material, and grinding the raw material to the target particle size by the grinding mill 1; or directly using an existing material having a particle size smaller than or equal to the target particle size; conveying the raw material having the target particle size via the first belt conveyor 41 and then storing the raw material in the ground material feeding container 21; and
adding a desired designed amount of water to the silo 3;
step two: preparing mineral muddy water;
in a case of preparing the artificial clay, performing a sub-step a; in a case of preparing the artificial organic ecological mud, performing a sub-step b;
the sub-step a, extracting a desired designed amount of raw material from the ground material feeding container 21, and conveying the raw material into the silo 3 via the second belt conveyor 42, with the agitator 5 continuously stirring during conveying to prevent the raw material entering the silo 3 from bubbling and caking, and after the raw material is completely poured into the silo 3, continuing to stir by the agitator 5 until the raw material and the water are completely and uniformly mixed, thus obtaining the mineral muddy water;
the sub-step b, extracting a desired designed amount of organic material from the organic material feeding container 22, and conveying the organic material into the silo 3 via the second conveyor belt 42, with the agitator 5 continuously stirring during conveying until the organic material and the water are completely and uniformly mixed, thus obtaining nutrient aqueous solution;
extracting the desired designed amount of the raw material from the ground material feeding container 21, and conveying the raw material into the silo 3 via the second belt conveyor 42, with the agitator 5 continuously stirring during conveying to prevent the raw material entering the silo 3 from bubbling and caking, and after the designed amount of raw material is completely poured into the silo 3, continuing to stir by the agitator 5 until the raw material and the nutrient aqueous solution are completely and uniformly mixed, thus obtaining the mineral muddy water;
step three: preparing flocculent mineral solution;
extracting a desired designed amount of a mixture of one or more of flocculants, aggregating agents or water-retaining agents from the flocculation feed container 23, and then conveying the mixture into the silo 3 via the second belt conveyor 42, with the agitator 5 continuously stirring during conveying until the mixture and the mineral muddy water are completely and uniformly mixed, thus forming the flocculent mineral solution; and
step four: reacting and dehydrating to form artificial clay or artificial organic ecological mud;
reserving the reaction time according to the reaction time of 72 hours per ton of granules (the reaction time for one ton of raw material is 72 hours, which is increased in equal proportion, but at least 24 hours), enabling substances in the flocculent mineral solution prepared in step three to fully react, and then conveying the flocculent mineral solution in the step three into the dehydration system 6 via the first water pipe 81 to be concentrated, filter-pressed and compressed to obtain the artificial clay or artificial organic ecological mud, wherein the wastewater generated in the dehydration process is conveyed into the reservoir 7 via the second water pipe 82.

The organic material selected in the step two is a general term, which is a mixture of microbial inoculants and one or more of organic fertilizers, inorganic fertilizers, biological fertilizers, and crushed organic materials.

The microbial inoculants are market available microbial inoculants for soil improvement.

The dehydration system 6 in the step four is a dehydrator for sludge effluent treatment.

The following will describe the technical solutions of the embodiments of the present disclosure clearly and completely with reference to the accompanying drawings.

Embodiment 1: Preparation of Artificial Clay
step one: raw material preparation
selecting existing dolomite having a particle size less than or equal to 4 μm as a basic raw material;
step two: preparing mineral muddy water;
adding 200 mL of water to a 500 mL beaker, pouring a designed amount of raw material in the step one (150 g) into the water, stirring while pouring to avoid bubbling and caking in the process, and after the raw material is completely poured into the water, continuing to stir until the raw material and the water are completely and uniformly mixed, thus obtaining the mineral muddy water;
step three: preparing flocculent mineral solution
pouring 0.01 g of aggregating agent into the mineral muddy water in the step three, stirring while pouring until the aggregating agent and the mineral muddy water are completely and uniformly mixed, thus forming the flocculent mineral solution;
step four, reacting and dehydrating to form the artificial clay;
after standing for 24 hours, conveying the flocculent mineral solution in the step three into the dehydration system (a linear dehydration sieve) to be concentrated, filter-pressed and compressed to obtain artificial clay.

Embodiment 2: Preparation of Artificial Organic Ecological Mud
step one: raw material preparation;
selecting coal gangue as a raw material, firstly crushing the coal gangue by using a hammer crusher until the particle size is 5 mm to 10 mm, and then grinding the coal gangue by using an ultrafine grinding mill until the particle size is less than or equal to 5 μm;
step two: preparing nutrient aqueous solution;
adding 200 mL of water to a 500 mL beaker, taking a designed amount of organic material (1 g of penicillium oxalicum, 0.2 g of urea nitrogen fertilizer, and 0.02 g of plant ash), stirring the organic material using a glass rod until the organic material and the water are completely and uniformly mixed, thus obtaining the nutrient aqueous solution;
step three: preparing mineral muddy water;
pouring a designed amount of raw material in the step one (100 g) into the nutrient aqueous solution in the step two, stirring while pouring to avoid bubbling and caking in the process, and after the raw material is completely poured into the nutrient aqueous solution, continuing to stir until the raw material and the nutrient aqueous solution are completely and uniformly mixed, thus obtaining the mineral muddy water;
step four: preparing flocculent mineral solution
pouring 0.01 g of anionic flocculant into the mineral muddy water in the step three, stirring while pouring until the anionic flocculant and the mineral muddy water are completely and uniformly mixed, thus forming the flocculent mineral solution;
step five: reacting and dehydrating to form the artificial organic ecological mud;
after standing for 24 hours, conveying the flocculent mineral solution in the step four to the dehydration system (a linear dehydration sieve) to be concentrated, filter-pressed and compressed to obtain the artificial organic ecological mud.

Embodiment 3

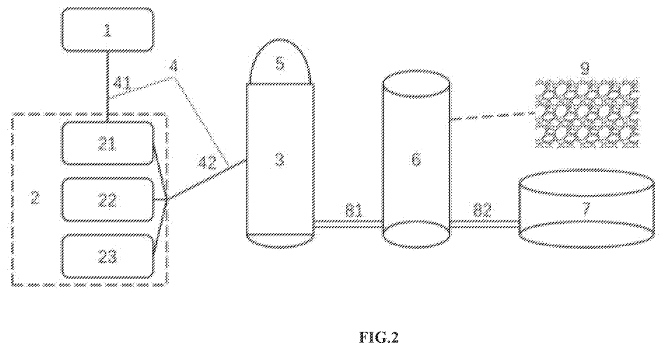

As shown in FIG. 2, a device for rapidly forming artificial clay and artificial organic ecological mud is provided, comprising an ultrafine grinding mill 1, a feeding system 2 (a ground material feeding container 21, an organic material feeding container 22, and a flocculation feeding container 23), a silo 3, a belt conveyor 4 (a first belt conveyor 41 and a second belt conveyor 42), an agitator 5, a dehydration system 6 and a reservoir 7. The ground material feeding container 21, the organic material feeding container 22, and the flocculation feeding container 23 are three separate containers, wherein the ground material feeding container 21 is used for storing a material having a target particle size; the organic material feeding container 22 is used for storing an organic material, and the flocculation feeding container 23 is used for storing a mixture of one or more of flocculants, aggregating agents or water-retaining agents; and the three feeding containers are used for feeding the silo 3 via the belt conveyor 4. The grinding mill 1 is used to grind the material to the target particle size, the ground material enters the ground material feeding container 21 via the first belt conveyor 41. The silo 3 is a reaction pool; an outlet of the silo 3 communicates with an inlet of the dehydration system via the first water pipe 81, and the agitator 5 is arranged in the silo 3. The agitator 5 is used for stirring the solution to make the solution be sufficiently mixed. The dehydration system 6 is used for dehydrating the flocculent mineral solution to obtain a with low water content. An outlet of the dehydration system communicates with the reservoir 7 via the second water pipe 82. The reservoir 7 is used for storing wastewater generated in the dehydration link, which can be used for plant irrigation at a later stage.

A method for rapidly forming artificial clay and artificial organic ecological mud by using the device above comprises the following steps:
step one: selecting coal gangue as a raw material, firstly crushing the coal gangue by using a hammer crusher until the particle size is 5 mm to 10 mm, and then grinding the coal gangue by using an ultrafine grinder until the particle size is less than 3 μm, conveying the obtained material via the first belt conveyor 41, and storing the obtained material in the ground material feeding container 21; and adding 20 L of water to the silo 3;
step two: in a case of preparing the artificial clay, performing a sub-step a; in a case of preparing the artificial organic ecological mud, performing a sub-step b;
the sub-step a, extracting a desired designed amount of the coal gangue material (10 kg) from the ground material feeding container 21, and conveying the coal gangue material into the silo 3 via the second belt conveyor 42, with the agitator 5 continuously stirring during conveying to prevent the raw material entering the silo 3 from bubbling and caking, and after the designed amount of raw material is completely poured into the silo 3, continuing to stir by the agitator 5 until the raw material and the water are completely and uniformly mixed, thus obtaining the mineral muddy water;
the sub-step b, extracting a desired designed amount of organic material (1 g of penicillium oxalicum, 20 g of nitrogen phosphorus and potassium compound fertilizer, 100 g of vermicompost, and 20 g of crushed straw material) from the organic material feeding container 22, conveying the organic material into the silo 3 via the second belt conveyor 42, with the agitator 5 continuously stirring during conveying until the organic material and the water are completely and uniformly mixed, thus obtaining the nutrient aqueous solution;
extracting the desired designed amount of the coal gangue material (10 kg) from the ground material feeding container 21, and conveying the coal gangue material into the silo 3 via second belt conveyor 42, with the agitator 5 continuously stirring during conveying to prevent the raw material entering the silo 3 from bubbling and caking, and after the designed amount of raw material is completely poured into the silo 3, continuing to stir by the agitator 5 until the raw material and the nutrient aqueous solution are completely and uniformly mixed, thus obtaining the mineral muddy water;
step three: extracting a mixture of 0.1 g of aggregating agent and 0.1 g of water-retaining agent from the flocculation feeding container 23, and conveying the mixture into the silo 3 via the second belt conveyor 42, with the agitator 5 continuously stirring until the mixture and the mineral muddy water are completely and uniformly mixed, thus forming the flocculent mineral solution;
step four, reacting for 24 h until the substances in the flocculent mineral solution in the step four react sufficiently, then conveying the flocculent mineral solution to the dehydration system 6 to be concentrated, filter-pressed and compressed to obtain an artificial organic ecological, wherein the wastewater generated in the dehydration process is conveyed to the reservoir 7 via the second water pipe 82.

It should be noted that the above embodiments are only used to illustrate the technical solutions of the present disclosure rather than limiting the same. Although the present disclosure has been described in detail with reference to the foregoing embodiments, it should be understood by those of ordinary skill in the art that it is still possible to modify the technical solutions recorded in the foregoing embodiments, or to equivalently replace some or all of technical features; and that these modifications or replacements do not make the essence of the corresponding technical solutions deviate from the scope of the technical solutions of the embodiments of the present invention.

1. A method for rapidly forming artificial clay and artificial organic ecological mud, comprising the following steps:
a step one of raw material preparation and water storage preparation comprising:
selecting the desired types of rocks, soil particles or mining industry solid wastes or various other materials having a particle size greater than a target particle size as a raw material, and grinding the raw material to the target particle size; or directly using an existing material having a particle size smaller than or equal to the target particle size; and preparing water;
a step two of preparing mineral muddy water comprising:
in a case of preparing the artificial clay, performing a sub-step a; and in a case of preparing the artificial organic ecological mud, performing a sub-step b,
wherein the sub-step a comprises: pouring a designed amount of raw material in the step one into a designed amount of water prepared in the step one, stirring while pouring the raw material to avoid bubbling and caking in the process, and after the raw material is completely poured into the water, continuing to stir until the raw material and the water are completely and uniformly mixed, thus obtaining the mineral muddy water;
wherein the sub-step b, comprises: pouring a designed amount of organic material into a designed amount of water prepared in the step one, stirring while pouring the organic material until the organic material and the water are completely and uniformly mixed, thus obtaining nutrient aqueous solution, wherein the organic material is a mixture of microbial inoculants and one or more of organic fertilizers, inorganic fertilizers, biological fertilizers, and crushed organic materials; and
pouring the designed amount of the raw material in the step one into the nutrient aqueous solution, stirring while pouring the raw material to avoid bubbling and caking in the process, and after the raw material is completely poured into the nutrient aqueous solution, continuing to stir until the raw material and the nutrient aqueous solution are completely and uniformly mixed, thus obtaining the mineral muddy water;
a step three of preparing flocculent mineral solution comprising:
taking a designed amount of a mixture of one or more of flocculants, aggregating agents or water-retaining agents, and pouring the mixture into the prepared mineral muddy water, and stirring while pouring the mixture until the mixture and the mineral muddy water are completely and uniformly mixed, thus forming the flocculent mineral solution; and
a step four of reacting and dehydrating to form artificial clay or artificial organic ecological mud comprising:
reserving reaction time according to the reaction time of not less than 24 hours, enabling substances in the flocculent mineral solution prepared in step three to fully react, and then conveying the flocculent mineral solution to the dehydration system to be concentrated, filter-pressed and compressed to obtain the artificial clay or artificial organic ecological mud.

2. The method for rapidly forming artificial clay and artificial organic ecological mud according to claim 1, wherein the target particle size in the step one has an upper value limit of 5 μm.

3. The method for rapidly forming artificial clay and artificial organic ecological mud according to claim 1, wherein in the step four, the reaction time is reserved according to the reaction time of 72 hours per ton of granules.

4. A device for rapidly forming artificial clay and artificial organic ecological mud, comprising a grinding mill, a feeding system, a silo, a belt conveyor, an agitator, a dehydration system, and a reservoir, wherein a discharge port of the grinding mill communicates with a feed port of the feeding system via the belt conveyor, a discharge port of the feeding system communicates with an inlet of the silo via the belt conveyor, an outlet of the silo communicates with an inlet of the dehydration system via a first water pipe, an outlet of the dehydration system communicates with the reservoir via a second water pipe, and the agitator is arranged in the silo.

5. The device for rapidly forming artificial clay and artificial organic ecological mud according to claim 4, wherein the feeding system comprises a ground material feeding container, an organic material feeding container and a flocculation feeding container, wherein the ground material feeding container is used for storing the material having the target particle size; the organic material feeding container is used for storing the organic material, and the flocculation feeding container is used for storing a mixture of one or more of flocculants, aggregating agents or water-retaining agents; and the three feeding containers are used for feeding the silo via the belt conveyor.

6. The device for rapidly forming artificial clay and artificial organic ecological mud according to claim 5, wherein the belt conveyor comprises a first belt conveyor and a second belt conveyor, wherein the discharge port of the grinding mill communicates with a feed port of the first belt conveyor, a discharge port of the first belt conveyor communicates with a feed port of the ground material feeding container, a discharge port of the ground material feeding container, a discharge port of the organic material feeding container, and a discharge port of the flocculation feeding container all communicate with a feed port of the second belt conveyor, and a discharge port of the second belt conveyor communicates with the inlet of the silo.

7. The device for rapidly forming artificial clay and artificial organic ecological mud according to claim 6, wherein the agitator comprises a driving motor, a connecting rod, and stirring impellers, wherein the top of the connecting rod is connected to an output shaft of the driving motor to rotate under the driving of the output shaft of the driving motor, a plurality of stirring impellers are fixed to the lower side of the connecting rod, the connecting rod with the stirring impellers extend into the silo, and the driving motor is fixed to the top of the silo.

8. A method for rapidly forming artificial clay and artificial organic ecological mud by using the device for rapidly forming artificial clay and artificial organic ecological mud according to claim 4, comprising the following steps:
a step one of raw material preparation and reaction pool preparation comprising:
selecting the desired types of rocks, soil particles or mining industry solid wastes or various other materials having a particle size greater than a target particle size as a raw material, and grinding the raw material to the target particle size by the grinding mill; or directly using an existing material having a particle size smaller than or equal to the target particle size; conveying the raw material having the target particle size via the first belt conveyor and then storing the raw material in the ground material feeding container; and adding a desired designed amount of water to the silo;
a step two of preparing mineral muddy water comprising:
in a case of preparing the artificial clay, performing a sub-step a; and in a case of preparing the artificial organic ecological mud, performing a sub-step,
wherein the sub-step a comprises extracting a desired designed amount of raw material from the ground material feeding container, and conveying the raw material into the silo via the second belt conveyor, with the agitator 5 continuously stirring during conveying to prevent the raw material entering the silo from bubbling and caking, and after the raw material is completely poured into the silo, continuing to stir by the agitator until the raw material and the water are completely and uniformly mixed, thus obtaining the mineral muddy water;
wherein the sub-step b comprises extracting a desired designed amount of organic material from the organic material feeding container, and conveying the organic material into the silo via the second conveyor belt, with the agitator continuously stirring during conveying until the organic material and the water are completely and uniformly mixed, thus obtaining nutrient aqueous solution; and
extracting the desired designed amount of the raw material from the ground material feeding container, and conveying the raw material into the silo via the second belt conveyor, with the agitator continuously stirring during conveying to prevent the raw material entering the silo from bubbling and caking, and after the designed amount of raw material is completely poured into the silo, continuing to stir by the agitator until the raw material and the nutrient aqueous solution are completely and uniformly mixed, thus obtaining the mineral muddy water;
a step three of preparing flocculent mineral solution comprising:
extracting a desired designed amount of a mixture of one or more of flocculants, aggregating agents or water-retaining agents from the flocculation feed container, and then conveying the mixture into the silo via the second belt conveyor, with the agitator continuously stirring during conveying until the mixture and the mineral muddy water are completely and uniformly mixed, thus forming the flocculent mineral solution; and
a step four of reacting and dehydrating to form artificial clay or artificial organic ecological mud comprising:
reserving reaction time according to the reaction time of 72 hours per ton of granules, enabling substances in the flocculent mineral solution prepared in step three to fully react, and then conveying the flocculent mineral solution into the dehydration system via the first water pipe to be concentrated, filter-pressed and compressed to obtain the artificial clay or artificial organic ecological mud, wherein the wastewater generated in the dehydration process is conveyed into the reservoir via the second water pipe.

9. The method for rapidly forming artificial clay and artificial organic ecological mud according to claim 8, wherein the organic material selected in the step two is a mixture of microbial inoculants and one or more of organic fertilizers, inorganic fertilizers, biological fertilizers, and crushed organic materials.

10. The method for rapidly forming artificial clay and artificial organic ecological mud according to claim 8, wherein the feeding system comprises a ground material feeding container, an organic material feeding container and a flocculation feeding container, wherein the ground material feeding container is used for storing the material having the target particle size; the organic material feeding container is used for storing the organic material, and the flocculation feeding container is used for storing a mixture of one or more of flocculants, aggregating agents or water-retaining agents; and the three feeding containers are used for feeding the silo via the belt conveyor.

11. The method for rapidly forming artificial clay and artificial organic ecological mud according to claim 10, wherein the belt conveyor comprises a first belt conveyor and a second belt conveyor, wherein the discharge port of the grinding mill communicates with a feed port of the first belt conveyor, a discharge port of the first belt conveyor communicates with a feed port of the ground material feeding container, a discharge port of the ground material feeding container, a discharge port of the organic material feeding container, and a discharge port of the flocculation feeding container all communicate with a feed port of the second belt conveyor, and a discharge port of the second belt conveyor communicates with the inlet of the silo.

12. The method for rapidly forming artificial clay and artificial organic ecological mud according to claim 11, wherein the agitator comprises a driving motor, a connecting rod, and stirring impellers, wherein the top of the connecting rod is connected to an output shaft of the driving motor to rotate under the driving of the output shaft of the driving motor, a plurality of stirring impellers are fixed to the lower side of the connecting rod, the connecting rod with the stirring impellers extend into the silo, and the driving motor is fixed to the top of the silo.

13. The method for rapidly forming artificial clay and artificial organic ecological mud according to claim 10, wherein the organic material selected in the step two is a mixture of microbial inoculants and one or more of organic fertilizers, inorganic fertilizers, biological fertilizers, and crushed organic materials.

14. The method for rapidly forming artificial clay and artificial organic ecological mud according to claim 11, wherein the organic material selected in the step two is a mixture of microbial inoculants and one or more of organic fertilizers, inorganic fertilizers, biological fertilizers and crushed organic materials.

15. The method for rapidly forming artificial clay and artificial organic ecological mud according to claim 12, wherein the organic material selected in the step two is a mixture of microbial inoculants and one or more of organic fertilizers, inorganic fertilizers, biological fertilizers, and crushed organic materials.
